(19) United States
(12) Patent Application Publication
(10) Pub. No.: US 2004/0096249 A1
(43) Pub. Date: May 20, 2004

(54) Method and device for fusing toner onto a substrate

(76) Inventors: Knut Behnke, Kiel (DE); Hans-Otto Krause, Eckernfoerde (DE); Frank-Michael Morgenweck, Molfsee (DE); Domingo Rohde, Kiel (DE); Detlef Schulze-Hagenest, Molfsee (DE); Lars Seimetz, Achterwehr (DE)

Correspondence Address: Lawrence P. Kessler, Patent Department, NexPress Solution LLC, 1447 St. Paul Street, Rochester, NY, 14653-7103, US

(21) Appl. No.: 10/422,188

(22) Filed: Apr. 24, 2003

(30) Foreign Application Priority Data
Jun. 7, 2002 (DE) 102 25 604.7

(51) Int. Cl. G03G 15/20

(52) U.S. Cl. 399/328

(57) ABSTRACT

Fusing toner onto a substrate, in which a fusing device (fuser), preferably including a heatable fusing roller in contact with the toner, is used to heat the toner to a temperature that is higher or equal to its glass transition temperature. Prior to the heating of the toner by the fusing device, a contact-free preheating is carried out, with which the toner is first heated to a temperature that is lower or equal to its glass transition temperature.

### FIELD OF THE INVENTION

The invention relates to fusing toner onto a substrate, in which a fusing device (fuser), preferably including a heatable fusing rollers in contact with the toner is used in order to heat the toner to a temperature that is higher or equal to its glass transition temperature.

### BACKGROUND OF THE INVENTION

With electrostatic or electrophotographic printing, a latent electrostatic image with charged toner particles is created on an illustration drum and transferred to a substrate or to a print substrate, such as, in particular, paper in form of sheets or in the form of a continuous conveyor belt. Here, for example, in four-color printing, four latent images in the four-color separations (cyan, magenta, yellow, and black) are transferred in succession and on top of one another to the substrate. In particular, the finished one-color or multicolored latent image is then fused by a fusing device onto the substrate. This normally takes place by a heatable fusing roller, which is rolled onto a toner image and there the toner is heated above its glass transition temperature, which thus melts, and is simultaneously incorporated under pressurization into the substrate, to which it is fused after it has been cooled. Adjacent toner particles are thereby combined, which finally form a polymer layer on the substrate.

A problem can occur with the described procedure, if a greater number of printing processes is to be carried out within a specific period of time, such that the method should be accelerated. Then the fusing process may prove to be the speed-limiting factor of the printing process, because it cannot be linearly accelerated.

If the fusing process needs to be accelerated, it may be thought that the temperature of the fusing roller needs to be increased and/or that the fusing area between the fusing roller and a counter-pressure roller needs to be enlarged in the substrate-transfer direction.

However, an increase in the temperature leads to a reduced service life of the fusing roller, particularly its sheathing or cladding. Furthermore, during the fusing process with a fusing roller, silicone oil is used as a separating agent, to prevent the toner from sticking to the fusing roller and damaging subsequent printing processes. In addition, this oil must be frequently topped up and its use increases, whereby there is also the danger of it sticking to the conveying devices, soiling them and tracking it further, so that this oil may also damage subsequent printing processes.

If the fusing area is to be enlarged, this can be accomplished in two ways. The pressure between the fusing roller and the counter-pressure roller can be increased and, as a result, a larger flattened area is created, or a fusing roller with a larger diameter can be used. Increasing the pressure may in turn reduce the service life of the fusing roller, particularly its sheathing, and this can lead to substrate damages, and, in particular, to the crumbling of the substrate. If the diameter of the fusing roller is increased, this may easily lead to jamming of the substrate. As a result, the construction costs and dimensions become problematic.

The object of the invention is thus based, in particular for an increased speed, to relieve the fusing device with a method or a device of the above-mentioned type, so that the transfer of any problems in the previously described manner occurs only locally.

### SUMMARY OF THE INVENTION

This object is solved according to the invention in that prior to the heating of the toner by the fusing device, a contact-free preheating is carried out, in which the toner is first heated to a temperature that is lower or equal to its glass transition temperature.

“Preheating” means that the toner is heated up to the range of its glass transition temperature, but this temperature is not exceeded, so as to prevent a melting of the toner. On the other hand, “fusing” includes a heating of the toner above its glass transition temperature. However, toner with a clearly defined glass transition temperature is preferably used, such that a preheating and a fusing with their temperature ranges may thus closely abut each other.

The fusing process is in particular relieved by the contact-free preheating according to the invention, as is the danger of substrate jamming, without the problem being transferred from the fusing range into the preheating range. In this instance, contact-free preheating is particularly advantageous.

A contacting preheating by a heatable saddle, which may be pressed against the substrate carrying the toner to heat it is, in principle, known, for example from the U.S. Pat. No. 4,147,922. However, these types of saddles have relatively large dimensions and may, in particular with the so-called double-sided printing (i.e., the two-sided printing of a substrate on the first page and on the back of a page), cause problems, because this type of saddle must be so highly heated that a printing image that has already been fused onto the first side (verso) of the substrate may be softened again and smeared, especially if a counter-pressure component lies directly beneath this underside. On the other hand, with the contact-free preheating according to the invention, a precise and constant temperature can be set that is clearly below the glass transition temperature, and if necessary, the substrate can even be carried “floating” on an air cushion, for example. According to the invention, the preheating preferably takes place by a microwave application, with which the substrate is advantageously and indirectly over the substrate, warmed, but the toner is also sometimes indirectly heated.

In particular, the method according to the invention can be applied to the substrate sheets or (continuously) to the substrate conveyor belt. The application of any technique can be considered as the actual fusing step, such as a contact-free fusing by microwaves, infrared radiation, etc., or contact by a belt or a fusing roller, etc. Here other printing quality parameters, such as toner gloss, may also be taken into consideration.

Preferably, the method according to the invention provides that resonant or standing microwaves are applied. By the range and/or tuning of the resonators, work can hereby be very targeted to meet the requirements, and, in particular, different printing quality characteristics can be taken into consideration, as is the case with other methods to be shown later on.

In order to achieve a better energy input, the substrate can be moistened prior to the microwave application. For example, this could be accomplished with 100° C. hot steam. As a result, the substrate may preferably be moistened on both sides, in order to avoid stressing and bending of the substrate. Furthermore, the substrate carrying the toner is already warmed by the condensation heat.

Another further development of the method according to the invention may be that a conveyance (e.g., a suction belt or an electrostatic conveyor belt for conveying the substrate from the preheating site to the site for fusing the toner) can be arranged to maintain a constant temperature of preferably approximately 40° C.

In order to save energy or for a high efficiency, waste heat or waste energy can be used to the greatest degree possible for heating. For example, waste heat or energy from a magnetron, a circulator or a water load can be used. In this manner, for example, purging air can be heated.

On a magnetron, bridging and averting wave guides can be used up to the applicator. To prevent leakage radiation in the area around the applicator, a so-called choke structure with lip-type protrusions can be envisaged for material splits. In addition, absorbent material can be used on the outside of the applicator.

Self-protection is required for a device to fuse toner onto a substrate comprising a fusing device (fuser), preferably with a heatable fusing roller in contact with the toner, in order to heat the toner to a temperature that is higher or equal to its glass transition temperature, preferably for carrying out the method according to the invention, which, according to the invention, is characterized by a preheating device for contact-free preheating of the toner to a temperature that is lower or equal to its glass transition temperature. In particular, the device according to the invention may comprise at least one microwave source, to which the preheating device for a preheating by a microwave application is connected. Herein the preheating device may preferably comprise at least one microwave resonator for the generation of standing microwaves. In particular, several resonators with horizontally running microwaves in succession in the substrate transfer direction may be transversely offset from each other around a fraction of the microwave length, in order to have the most evenly distributed heating over the width of the substrate. However, for example, resonators can also be transversely offset from each other, which generate perpendicular microwaves running through the substrate.

A major configuration of a device according to the invention can be, for example, a combination of a preheating device and a fusing device, with which at least one conveyance that transfers the substrate into the preheating device, followed by a cooling stretch for the substrate carrying the toner, in order to again cool the toner down to below its glass transition temperature. In this manner, for the microwave application, all the known types of one or more microwave applicators for the generation of resonant or non-resonant microwaves can be used for the preheating.

Furthermore, the device may be easy to open, for example, with a clamping type of construction, so that in the event of a jamming of the substrate, the substrate path is accessible to preheating.

For a resonant microwave generation, a contacting or contact-free plunger is customarily used to tune the microwave applicators. For the exact determination of the applicator geometry, this type of plunger or tuner is not necessary. The plunger can be replaced by a specified placement of an end wall, and the tuner can be replaced by fixed metal stubs and/or by blocks made of polytetrafluorethylene in a wave guide for adjustment of the length of the wave guide between the microwave source and the aperture. The aperture, which the resonant cavity defines, can be any shape, in particular a right angle, spherical or a bent shape.

In the event in particular of the use of a TEION resonator, the wavelength in the resonator, i.e., the distance between the peak-to-peak intervals, can be optimized by the width of the resonator perpendicular to the substrate plane. With a width of 94 mm, for example, the distance between the peak-to-peak intervals is 84 mm. Thus, with the overlapping of two applicators, an absolute tolerance of the substrate temperature of 6° C. (±3° C., corresponding to ±5%) can be achieved. With a width of 109 mm, for example, the distance between the peak-to-peak intervals is only 73 mm, which leads to a tolerance of 4° C. (±2° C., corresponding to ±3%).

The height of a resonator in the substrate transfer direction is optimized to achieve a high electric field strength, without discharges into the applicator. Good results are thus achieved with heights such as 54 mm, 34 mm, 24 mm and 20 mm. The smaller values are preferred for higher electric field strength. High electric field strength increases the efficiency of the microwave system for substrates with lower losses, as with paper, for example.

The frequency modulation of a resonant applicator is size-dependent in the machine direction (lengthwise). After a longer operating period, the heating of the applicator by wall losses, contingent upon the surface currents on the inner surface of the applicator, induced by the microwave radiation in the applicator, leads to a detuning of the resonant applicator. In order to avoid this, it is recommended positioning the frequency-determining components of the resonant applicator (aperture and plunger) so that they are temperature independent or possibly temperature stabilized by each other, whereby the applicator itself is positioned so that it can move, so that the inner dimensions of the resonant applicator do not change during continuous operation.

The invention, and its objects and advantages, will become more apparent in the detailed description of the preferred embodiment presented below.

### BRIEF DESCRIPTION OF THE DRAWINGS

In the detailed description of the preferred embodiment of the invention presented below, embodiments and application examples, from which other inventive features may arise, to which the scope of the invention is, however, not limited, are illustrated in the drawing and are explained in greater detail in conjuction with the drawings. Reference is made to the accompanying drawings, in which:

FIG. 1 is an experimental configuration of a combination of a preheating device and a fusing device according to the invention;

FIG. 2 is a first temperature distribution with a first application of the configuration according to FIG. 1; and

FIG. 3 is a second temperature distribution with a second application of a configuration according to FIG. 1.

### DETAILED DESCIRIPTION OF THE INVENTION

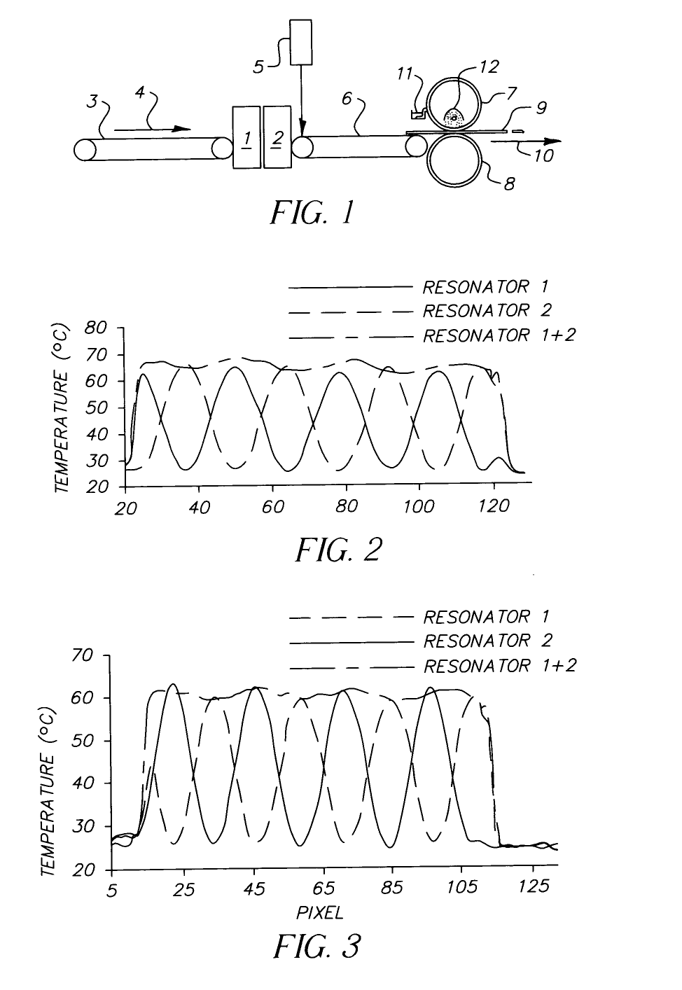

Referring now to the accompanying drawings, FIG. 1 shows a primary experimental configuration of a device according to the invention. It shows a preheating device, which includes two resonators 1 and 2 and to which a substrate to be preheated on a conveyor belt 3 is fed in the transfer direction 4. The conveyor belt 3 may be fused to the substrate by a vacuum or electrostatically.

The resonators 1, 2 are TELON resonators, which are oriented transversely to the transfer direction 4 and which are arranged in succession in the transfer direction. The resonators 1, 2 are actually in a manner and in a measure transversely offset from each other, so that the peak-to-peak intervals of the microwave of the first resonator 1 are exactly positioned on the gaps between the peak-to-peak intervals of the microwave of the subsequent resonator 2. The temperature that will be distributed with the resonators 1, 2 as uniformly as possible over the width of the substrate carrying the toner can be measured in the configuration in FIG. 1 with a line pyrometer 5 when exiting the resonators. If the device is measured and set in a satisfactory manner, it can be considered as the same device in FIG. 1 in principle, with the omission of the pyrometer 5, and also as an assembly in an electrophotographic printing machine.

The preheating device is conveyed from the resonators 1, 2 up to the fusing device by a second conveyor belt 6. With this conveyor belt 6, the substrate may even be further tempered.

The fusing device includes a fusing roller 7, illustrated in a cross-sectional view, which is heated by an internal heat source 12, such as a radiation source and to be precise, to a temperature above the glass transition temperature of the toner on the substrate. In the area of this fusing device, a toner-bearing sheet-like substrate 9 is indicated, which was fed after the fusing in the direction of the arrow 10 for cooling.

The fusing roller 7 is supplied by a schematically indicated oil reservoir 11 with silicone oil as the separating agent to prevent the adherence of toner to the fusing roller 7. A counter-pressure roller 8 together with the pressure-loaded fusing roller 7 serves as the abutment for the substrate 9.

FIG. 2 shows the progression of the temperature produced in the substrate by the resonators 1, 2 once with a dashed line, when only resonator 2 is turned on, once in a drawn through line when only resonator 1 is turned on, whereby the peak-to-peak intervals of resonator 1 are phase-delayed to the peak-to-peak intervals of resonator 2 exactly on the gaps or on a half wavelength of the wavelength of the standing wave, which corresponds to an energy input and which is only half as big as the wavelength of the originally fed free microwave. The temperatures are phase-delayed to the peak-to-peak intervals of resonator 2 exactly on the gaps or around a half wavelength of the wavelength illustrated in FIG. 2 (and FIG. 3) of the standing wave, which corresponds to the energy input and is only half as big as the wavelength of the originally fed in free microwave, and once in a drawn-through line as an encasing of both switched on resonators 1, 2. The encasing produces an almost uniform temperature of approximately 75° C. ±3° C. in the substrate that was applied on the abscissa across the width of the substrate. The temperatures were measured with a line pyrometer 5 according to FIG. 1. Therein a paper with a specific mass per unit area of 220 g/m was used as the substrate, with an advance rate of 50 cm/s, a microwave production rate of 2 kW per resonator and a pixel size of 3.1 mm.

In FIG. 3, a second temperature progression corresponding to FIG. 2 was applied, however this time with microwave peak-to-peak intervals, which are not as far apart as in the illustration of FIG. 2, which, as mentioned previously, can be set in advance or predetermined by the selected width of the resonator. By the smaller peak-to-peak intervals in FIG. 3, it can be seen that the temperature progression across the substrate width is still more uniform than in the case of FIG. 2.

The relieving of the fusing device by preheating according to the invention is further clarified below by tables. It can be deduced from the tables that a higher preheating of the paper as the substrate produces a shortening of the duration of the fusing process, thus permitting an increase in the paper transfer speed, as a result of which a higher printing speed can also be obtained with a printing machine without problems arising in the fusing process.

Thus, in Example 1 of Table 1, paper with a specific mass per unit area of 80 g/m and in Example 2 in Table 2, paper with a specific mass per unit area of 300 g/m² is used.

### EXAMPLE 1 (Table 1)

| | | Paper | Fusing | Toner/Paper | |
|---|---|---|---|---|---|
| Paper | Fusing | Tem- | Roller | Surface | |
| Speed | Time | perature | Temperature | Temperature | Comment |
| 30 cm/s | 60 ms | 27° C. | 160° C. | 112° C. | No Pre-Heating |
| 45 cm/s | 40 ms | 44° C. | 160° C. | 112° C. | 2 × 1500 kW |
| 60 cm/s | 30 ms | 54° C. | 160° C. | 110° C. | 2 × 2000 kW |

### EXAMPLE 2 (Table 2)

| | | Paper | Fusing | Toner/Paper | |
|---|---|---|---|---|---|
| Paper | Fusing | Tem- | Roller | Surface | |
| Speed | Time | perature | Temperature | Temperature | Comment |
| 30 cm/s | 60 ms | 27° C. | 160° C. | 112° C. | No Pre-Heating |
| 45 cm/s | 40 ms | 40° C. | 160° C. | 112° C. | 2 × 1500 kW |
| 60 cm/s | 30 ms | 48° C. | 160° C. | 112° C. | 2 × 2000 kW |

The invention has been described in detail with particular reference to certain preferred embodiments thereof, but it will be understood that variations and modifications can be effected within the spirit and scope of the invention.

What is claimed is:

1. Method for fusing toner onto a substrate, in which a fusing device including a heatable fusing roller in contact with the toner, is used in order to heat the toner to a temperature that is greater or equal to its glass transition temperature prior to the heating of the toner by the fusing device, comprising: the toner on said substrate without contact, wherein the toner is first heated to a temperature that is lower or equal to its glass transition temperature.

2. Method according to claim 1, wherein the preheating is carried out by a microwave application.

3. Method according to claim 2, wherein a resonant microwave application is carried out.

4. Method according to claim 3, wherein the substrate is moistened prior to the microwave application.

5. Method according to claim 1, wherein the conveyance for carrying the substrate from the preheating site to the site for the fusing of the toner is preferably maintained at a constant temperature of approximately 40° C.

6. Method according to claim 1, wherein waste heat or waste energy is used for preheating.

7. Device for fusing toner onto a substrate, including a fusing device with a heatable fusing roller in contact with the toner, in order to heat the toner to a temperature that is greater or equal to its glass transition temperature, comprising: a preheating device for contact-free preheating of the toner to a temperature that is lower or equal to its glass transition temperature.

8. Device according to claim 7, wherein the preheating device is connected to at least one microwave source.

9. Device according to claim 8, wherein the preheating device comprises at least one microwave resonator.
